(19) United States
(12) Patent Application Publication
(10) Pub. No.: US 2010/0211487 A1
(43) Pub. Date: Aug. 19, 2010

(54) GREEN POWER PAYMENT DEVICE

(76) Inventor: Steve Thorne, Berkeley, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 12/371,161

(22) Filed: Feb. 13, 2009

(51) Int. Cl. G06Q 20/00; G06Q 30/00; G06Q 50/00

(52) U.S. Cl. 705/34; 705/40

(57) ABSTRACT

A server computer comprising a processor and a computer readable medium coupled to the processor, wherein the computer readable medium comprises code executable by the processor. The computer readable medium comprises code for receiving transaction information associated with a purchase transaction of a sponsored product between a consumer and a merchant using a payment device, code for determining an energy credit based on the transaction information associated with the purchase transaction of the sponsored product, code for sending a first notification to a sponsor associated with the sponsored product. The first notification comprises a portion of the transaction information. The sponsor makes a payment associated with the determined energy credit to a renewable energy producer in response to receiving the first notification. The computer readable medium further comprises code for sending a second notification with the determined energy credit to an energy provider. The energy provider credits the energy service account of the consumer with the determined energy credit in response to receiving the second notification.

### BACKGROUND

The present invention relates generally to renewable energy production. More particularly, the present invention relates to a green power payment device (e.g., credit card) that offers rewards in energy credit applied to the cardholder's energy bill where the energy credit is derived from the production of renewable energy.

With concern over global warming, and the realization that major sources of energy such as oil are a limited resource that may be significantly depleted in the foreseeable future, there has been an increased interest in renewable energy production. Renewable energy is generated from sunlight, rain, tides, geothermal heat, and other naturally replenished sources.

In the United States, some states have a program that provides renewable energy certificates (RECs) to eligible renewable energy producers (e.g., wind farms). In these states, the renewable energy producers are given an REC for every 1,000 kilowatt hour (KWh) of electricity provided to the energy provider (e.g., Pacific Gas and Electric Company). The energy provided by the renewable energy producers is fed into the electrical grid and the RECs can be sold or traded in the market.

Although consumers could purchase RECs in the market to promote renewable energy production, consumers would like a simpler and more consistent way of becoming involved in the production of renewable energy.

### BRIEF SUMMARY OF THE INVENTION

According to the present invention, systems and methods are disclosed that relate to rewards for purchases and more particularly to rewards offered in energy credit for using a green power payment device wherein the energy credit is derived from the production of renewable energy. Merely by way of example, the present invention relates to a green power payment device that offers a reward for using the payment device for sponsored products in the form of an energy credit applied to the consumer's energy bill. However, it would be recognized that the invention has a much broader range of applicability.

An embodiment of the invention is directed to a server computer comprising a processor and a computer readable medium coupled to the processor. The computer readable medium comprises code executable by the processor such as code for receiving transaction information associated with a purchase transaction of a sponsored product between a consumer and a merchant using a payment device, code for determining an energy credit based on the transaction information associated with the purchase transaction of the sponsored product, and code for sending a first notification to a sponsor associated with the sponsored product. The first notification comprises a portion of the transaction information. The sponsor makes a payment associated with the determined energy credit to a renewable energy producer in response to receiving the first notification. The computer readable medium also comprises code for sending a second notification with the determined energy credit to an energy provider. The energy provider credits the energy service account of the consumer with the determined energy credit in response to receiving the second notification.

An embodiment of the invention is directed to a method comprising receiving, by a server computer, transaction information associated with a purchase transaction of a sponsored product between a consumer and a merchant using a payment device. The method also comprises determining, by a server computer, an energy credit based on the transaction information associated with the purchase transaction of the sponsored product. In addition, the method comprises sending, by a server computer, a first notification to a sponsor associated with the sponsored product. The first notification includes a portion of the transaction information. The sponsor makes a payment associated with the determined energy credit to a renewable energy producer in response to receiving the first notification. The method also comprises sending, by a server computer, a second notification with the determined energy credit to an energy provider, wherein the energy provider credits the energy service account of the consumer with the determined energy credit in response to receiving the second notification.

Another embodiment is directed to a method comprising initiating sending transaction information to a server computer of a transaction processor. The transaction information is associated with a purchase transaction of a sponsored product between a consumer and a merchant using a payment device. The server computer of the transaction processor determines an energy credit based on the transaction information associated with the purchase transaction of the sponsored product, sends a first notification to a sponsor associated with the sponsored product with a portion of the transaction information, and sends a second notification with the determined energy credit to an energy provider server. The method also comprises receiving a billing statement from the energy service provider indicating that the energy credit is credited to an energy service account.

For a further understanding of the nature and advantages of the invention, reference should be made to the following description taken in conjunction with the accompanying figures. It is to be expressly understood, however, that each of the figures is provided for the purpose of illustration and description only and is not intended as a definition of the limits of the embodiments of the present invention.

### BRIEF DESCRIPTION OF THE DRAWINGS

FIG. 1 is a block diagram of an exemplary system for conducting transactions using a green power payment device and providing rewards in energy credit, in accordance with an embodiment of the invention.

FIG. 2 is a plan view of an exemplary green power payment device in the form of a magnetic stripe card, in accordance with an embodiment of the invention.

FIG. 3 shows a flowchart of an exemplary method for conducting transactions using a green power payment device and for providing rewards associated with renewable energy production, in accordance with an embodiment of the invention.

FIG. 4 is an exemplary billing statement that shows a reward in the form of an energy credit applied to the energy usage, in accordance with an embodiment of the invention.

FIG. 5 shows a block diagram of subsystems that may be present in computer apparatuses that are used in a system, in accordance with an embodiment of the invention.

### DETAILED DESCRIPTION

Embodiments of the invention are directed to methods and systems for conducting transactions using a green power payment device (e.g., credit card) that offers rewards in energy credit applied to the cardholder's energy bill where the energy credit is derived from the production of renewable energy. A consumer uses their green power payment device to pay for a product (or service) at a merchant to initiate a purchase transaction. A message is sent from the merchant to a transaction processor with information about the transaction. The transaction processor authorizes (or declines) the transaction based on the transaction information. If the transaction is authorized, the transaction processor determines whether the product (or service) is sponsored. If the product is sponsored, the transaction processor determines a reward in energy credit for purchasing the sponsored product.

At some time after the transaction is authorized, the transaction processor sends a first notification with information about the reward to a sponsor associated with the sponsored product. The sponsor pays a renewable energy producer (e.g., a wind farm) an amount corresponding to the energy credit and the sponsor receives RECs in return. The renewable energy producer generates renewable energy (e.g., electricity from wind energy) and sells it to the consumer's local energy company that provides electricity to the consumer. The local energy company pays the renewable energy producer in RECs.

The transaction processor also sends a second notification to the local energy company with information about the reward along with information identifying the consumer. In response, the local energy company gives the consumer the reward by applying the energy credit to the consumer's account with the local energy company (e.g., PG&E® energy company). The consumer can view their reward on their billing statement (e.g., an energy bill). The billing statement shows the energy credit earned during the billing cycle and shows the total energy usage being reduced by the energy credit.

Certain embodiments of the invention may provide one or more advantages. An advantage to consumers may be the opportunity to link purchases with their green power payment device directly to renewable energy production. Embodiments of the invention give consumers the opportunity to participate in the green energy movement even if they do not have the substantial financial resources that may be required to participate in other ways such as in purchasing solar panels for their residences. Each purchase, large or small, becomes a way of participating in the green energy movement. Another advantage to consumers may be that the consumers receive rewards in the form of energy credit applied to their energy bill. An advantage to renewable energy producers may be that they receive payment for the renewable energy they provide from sponsors in addition to energy service companies. Thus, renewable energy producers may be able to increase their revenue from renewable energy production. An advantage to the general public may be a new stream of commerce for RECs that could result in an increase in the production of renewable energy. In addition, an advantage to sponsors may be to go green which allows them to distinguish themselves from other companies that do not go green.

Certain embodiments of the disclosure may include none, some, or all of the above technical advantages.

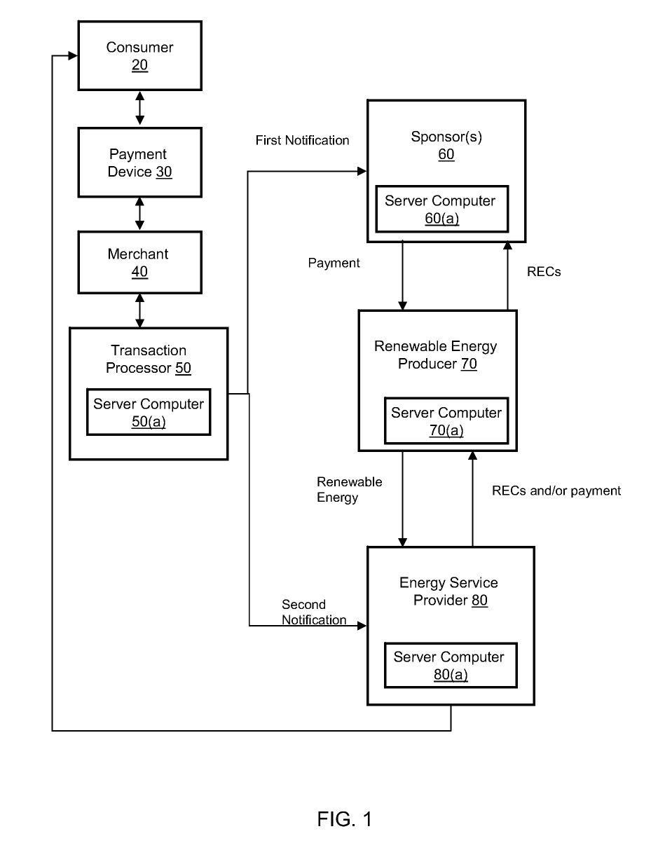

FIG. 1 is a block diagram of an exemplary system 10 for conducting transactions using a green power payment device 30 and providing rewards in energy credit, in accordance with an embodiment of the invention. The system 10 includes a consumer 20, a green power payment device 30, and a merchant 40. The consumer 20 is in operative communication with the green power payment device 30 to initiate a purchase transaction with the merchant 60 using the green power payment device 30. The green power payment device 30 is also in communication with the merchant 40 to communicate information about the purchase transaction to the merchant 40 to initiate the transaction.

The system 10 also includes a transaction processor 50 having a server computer 50(a), a renewable energy producer 70 having a server computer 70(a), and an the energy service provider 80 having a server computer 80(a). The transaction processor 50 has an account associated with the green power payment device 30. The transaction processor 50 is in communication with the sponsor 60 to send a first notification with information about the reward. The sponsor 60 is in communication with the renewable energy producer 70 to make a payment associated with the reward. In some cases, the sponsor 60 may receive RECs from the renewable energy producer 70 in return for the payment. The renewable energy producer 70 is in communication with the energy service provider 80 to provide renewable energy that it produces and to receive payment and/or RECs for the provided renewable energy. The energy service provider 80 is in communication with the consumer 20 to provide energy service (e.g., electricity service) to the consumer 20 and to send billing statements to the consumer 20 for the energy service provided. Energy service provider 80 has an energy account with consumer 20.

Although one consumer 20, one payment device 30, one merchant 40, one renewable energy producer 70, and one energy service provider 80 are shown in the illustrated embodiment, other embodiments may have any suitable number of these entities.

The consumer 20 may be an individual or an organization such as a business that is capable of using the green power payment device 30 to conduct a purchase transaction of a good and/or service. In most embodiments, the consumer 20 is the account holder having the account associated with the green power payment device 30. In other embodiments, consumer 20 may be a cardholder and a separate entity may be the accountholder. For example, consumer 20 may be a teen cardholder that uses the green power payment device 30 and the parent is the account holder.

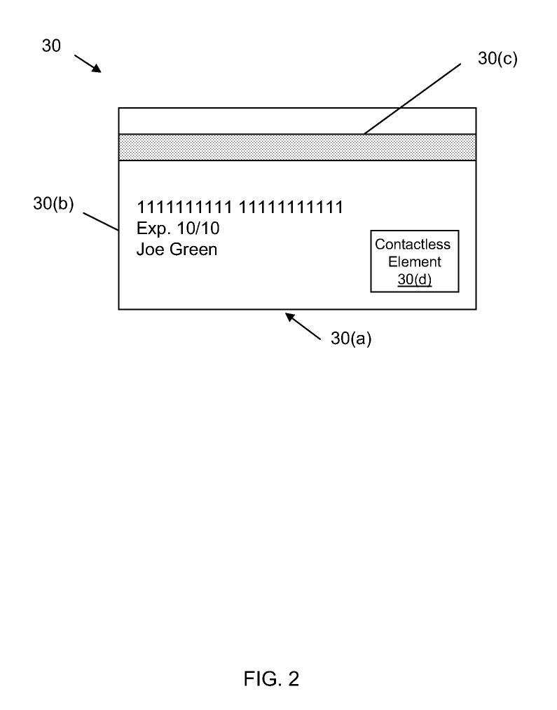

The green power payment device 30 refers to any device that allows the consumer 20 to conduct a purchase transaction of goods and/or services with the merchant 40. The green power payment device 30 may be in any suitable form and may be of any suitable size. An exemplary form of a green power payment device 30 is a payment card such as a credit card, a stored value card, a prepaid card, a debit card, etc. A payment card may be of any suitable type such as a smart card, a magnetic stripe card, etc. An exemplary green power payment device 30 in the form of a magnetic stripe card is shown in FIG. 2. Other examples of suitable forms of the green power payment device 30 include keychain devices, cellular phones, personal digital assistants (PDAs), pagers, security cards, access cards, transponders, and the like.

The green power payment device 30 may include any suitable component for performing its functions. In some embodiments, the green power payment device 30 includes a computer readable medium (CRM) and a processor (e.g., a microprocessor) coupled to the CRM. The CRM stores code for performing functions of green power payment device 30 and the processor executes the code to perform the functions. In one embodiment, the CRM comprises a) code for receiving information from a point of sale terminal at merchant 40, b) code for sending information to the point of sale terminal, and/or code for communicating information to consumer 20. The CRM may also store the account number and other data. The CRM may be any suitable combination of volatile and/or non-volatile memory. The CRM may be in any suitable form including a magnetic stripe, a memory chip, etc.

If the green power payment device 30 is in the form of a payment card, the card may have an embossed region (ER) 30(b) (shown in FIG. 2) which is embossed with an account number associated with the green power payment device 30 and other account information. The body 30(a) (shown in FIG. 2) of the green power payment device 30 may include any suitable structure such as a plastic substrate or housing. In addition, the green power payment device 30 may use any suitable electrical, magnetic, or optical interfacing system for interfacing with devices. For example, the green power payment device 30 may have a contactless element 30(d) (shown in FIG. 2) that uses radio frequency or magnetic field recognition. As another example, the green power payment device 30 may have a magnetic stripe 30(c) (shown in FIG. 2) that interfaces with a magnetic stripe reader.

The merchant 40 can be any entity that is capable of conducting transactions with the consumer 20 using the green power payment device 30. Some examples of merchants 40 include a department store, a gas station, a drug store, a grocery store, or other suitable business. The merchant 40 may use any suitable method to conduct the transaction. For example, the merchant 40 may be an e-commerce business that conducts transactions through the Internet. The merchant 40 may have a point of sale terminal or other suitable access device for communicating with the merchant 40 and interacting with the green power payment device 30. Some examples of other suitable devices include cellular phones, PDAs, automated teller machines, kiosks, personal computers, and the like. The point of sale terminal or other suitable access device uses any contact or contactless mode of communicating data to the green power payment device 30. The point of sale terminal or other suitable access device may include any suitable component. For example, the point of sale terminal or other suitable access device may include a reader such as a card reader that may include radio frequency (RF) antennas, optical scanners, bar code reader, magnetic stripe readers, etc. for interacting with the green power payment device 30. The merchant 40 may be associated with a bank that has an account with the merchant 40. The bank may process any payments to the merchant 40 and credit the payments to an account associated with the merchant 40.

The transaction processor 50 can be any combination of entities that are capable of processing transactions conducted using the green power payment device 30, capable of determining any rewards associated with the transactions, and capable of communicating information to the merchant 40, the sponsor 60, and the energy service provider 80. In some cases, the transaction processor 50 is also capable of issuing the green power payment device 30 to the consumer 20. The transaction processor 50 may include data processing subsystems, networks, and operations used to support and deliver authorization services, clearing and settlement services, and reward processing services.

The transaction processor 50 includes a server computer 50(a). As used herein, the term “server” or “server computer” generally refers to a powerful computer or cluster of computers. For example, a “server computer” can be a large mainframe, a minicomputer cluster, or a group of servers functioning as a unit. A “server computer” can include a computer readable medium (CRM) and a processor in communication with the CRM. The CRM can be memory. The CRM of the “server computer” stores code with instructions for performing the functions of the “server computer.” The processor executes the code stored on the CRM to perform the functions of the “server computer.” The “server computer” may also includes a database. A “database” may include any hardware, software, firmware, or combination of the preceding for storing and facilitating retrieval of information. Also, a “database” may use any of a variety of data structures, arrangements, and compilations to store and facilitate retrieval of information.

The server computer 50(a) of transaction processor 50 provides notifications to various entities in system 10 to communicate information such as information related to a reward and to the consumer 20 that earned the reward. A notification refers to any suitable message that is communicated between entities of system 10. Notifications may be in any suitable form and may be delivered by any suitable method. Some examples of notifications includes a phone call, a voice message, a voicemail message, a short message service (SMS) message e.g. a text message, an instant messaging (IM) message, or an email message. The notification may include an attachment in some cases. Notifications can be sent on any suitable basis such as hourly, daily, monthly, bimonthly, quarterly, and/or yearly.

The server computer 50(a) stores information such as account information. Account information refers to any information associated with the account associated with the green power payment device 30. Account information can include, for example, consumer information, transaction information, reward information, and other suitable information. Consumer information is information identifying the consumer 20 and the account such as, for example, a name, phone number, account number, bank identification number, etc. Reward information includes earned rewards associated with the account, a list of available offers for rewards, a list of the sponsors and their contact information, a list of sponsored products, and other information related to the rewards offered for purchasing products/service using the green power payment device 30. Transaction information includes the transaction amount, product identifiers, and other suitable information related to transactions conducted using the green power payment device 30.

The CRM of server computer 50(a) includes a) code for receiving transaction information associated with a purchase transaction of a sponsored product between the consumer 20 and the merchant 40 using a payment device 30, b) code for determining an energy credit based on the transaction information associated with the purchase transaction of sponsored products and/or non-sponsored products, c) code for sending notifications or other messages with transaction information to the sponsor 60, d) code for sending notifications or other messages with the energy credit to energy service providers 80(a), and/or e) other code for performing the functions of server computer 60(a).

Sponsor(s) 60 can be any entity (or entities) that offer rewards to consumers 20 for purchasing products/services using their green power payment devices 30. Sponsor 60 can be an individual or an organization (e.g., business). In some embodiments, sponsor(s) 60 offers rewards for purchases of sponsored products. A sponsored product is a product and/or service that is sponsored by a sponsor 60. A sponsor 60 may be, for example, a manufacturer, distributor, or seller (e.g., merchant 40) of the sponsored product.

A reward refers to any suitable value given to consumer 20 for using the green power payment device 30. Some examples of suitable values include a credit, a coupon, voucher, or other value. An exemplary reward is an energy credit given to consumer 20 for purchasing sponsored products using their green power payment device 30. An energy credit is a credit of an amount of electricity. For example, consumer 20 may earn an energy credit of 1000 kilowatt hour (KWh) of electricity for spending $1000 with their green power payment device 30.

A reward in energy credit can be provided to consumer 20 in any suitable form. An exemplary form is an energy credit applied to consumer's energy account with a local energy service provider 80 (e.g., PG&E® energy service provider). The energy credit can be applied to reduce the total energy usage in their account with their energy service provider 80. Another form of energy credit is in the form of a tradable certificate. For example, energy credit can be given to the consumer 20 in the form of renewable energy certificates (RECs). Each REC is a tradable environmental commodity that represents proof that 1 megawatt-hour (KWh) of electricity was generated by an eligible renewable energy provider.

Rewards can be associated in any suitable way with purchases made using the green power payment device 30. In some embodiments, rewards are offered for all purchases using the green power payment device 30. For example, a sponsor 60 may offer an energy credit of 1000 KWh for every $100 spent using their green power payment device 30. In other embodiments, rewards are offered only for purchases of sponsored products associated with one or more sponsors 80. For example, a sponsor 60 may offer the reward of 1000 KWh for every $100 spent on purchasing sponsored products with the green power payment device 30. As another example, sponsor 60 may offer the reward of 1000 KWh for purchasing 100 units of a sponsored product purchased with the green power payment device 30. In other examples, multiple sponsors 60 may offer cross promotional reward where multiple sponsors 60 jointly offer a reward for the purchase of sponsored products associated with different sponsors 60. For example, a first sponsor may sell a first sponsored product and a second sponsor may sell a second sponsored product. In this example, the first and second sponsors may offer a cross promotional reward of 1000 KWh for the combined purchase of 20 units of first sponsored product and 50 units of the second sponsored product. In yet other examples, a sponsor 60 may be a merchant 40 that offers rewards for any purchases using the green power payment device 30. For example, a merchant may offer 1000 KWh for every $100 spent purchasing products at their establishment using the green power payment device 30.

The server computer 60(a) includes a CRM that stores a) code for determining a payment associated with the energy credit, b) code for sending the payment to the renewable energy producer 70, c) code for receiving notifications and other messages from entities of system 10 such as server computer 50(a) of transaction processor 50, d) code for sending messages to entities of system 10, e) and/or other code for performing the functions of server computer 60(a).

Renewable energy is energy generated from natural resources that can be naturally replenished such as sunlight, wind, rain, waves, tides, geothermal heat, etc. A renewable energy producer 70 refers to any suitable entity capable of producing renewable energy and providing/selling the renewable energy to other entities such as an energy service provider 80. Some examples of suitable entities include a wind farm, hydroelectric dams, wave farms, solar thermal plants, photovoltaic power plants, geothermal plants, and other entities that produce renewable energy. In some embodiments, renewable energy producer 70 is an eligible renewable energy producer that is eligible to receive an REC from an energy service provider 80 for a predefined quantity of electricity (e.g., 1000 KWh or 1 MWh) that it produces and provides to the energy service provider 80.

Renewable energy producer 70 comprises a server computer 70(a). Server computer 70(a) includes a CRM having a) code for generating and providing renewable energy to the energy service provider 80, b) code for receiving payment from the sponsor 60, c) code for receiving RECs from energy service provider 80, and other code for performing the functions of server computer 70(a).

Energy service provider 80 refers to an entity that provides gas and/or electricity service to consumer 20. In some cases, energy service provider 80 also provides RECs in return for renewable energy provided by an eligible energy service provider. Some examples of energy service providers 100 are Pacific Gas and Electric Company (PG&E®), Texas Electric Company, TXU Energy Retail Company LLC, etc.

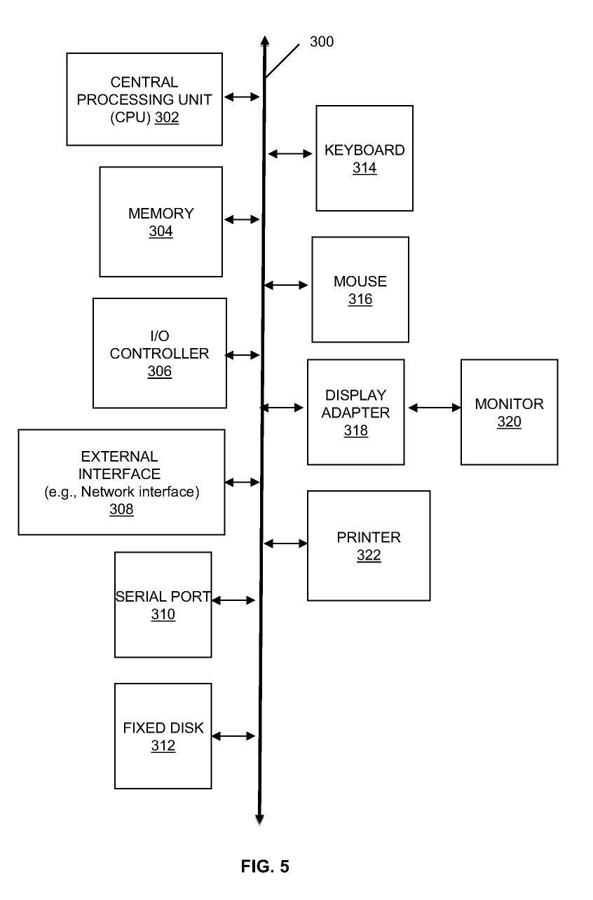

Energy service provider 80 has an energy account with consumer 20 to keep records of the service provided, payments made, and other information associated with the energy service. Energy service provider 80 sends consumer 20 a billing statement 500 (shown in FIG. 5) for a billing cycle (e.g., month, bi-month, quarter, or year) to notify consumer 20 of their charges and request payment. The billing statement 500 can include any suitable information regarding the status or other information related to the energy account. For example, the billing statement 500 includes the energy usage during that billing cycle. The billing statement 500 can also include the rewards of energy credit earned by the consumer 20 during that billing cycle and/or another time period (e.g., a year). The billing statement 500 also includes the energy account number, the name of the consumer 20, and other suitable information. The billing statement 500 can be provided in paper or electronic form.

Server computer 80(a) of energy service provider 80 includes a CRM that stores a) code for crediting the energy service account of the consumer 20 with the determined energy credit in response to receiving the second notification, b) code for generating billing statements for consumers 20, and other code for performing the functions of server computer 80(a).

Modifications, additions, or omissions may be made to system 10 without departing from the scope of the disclosure. The components of system 10 may be integrated or separated according to particular needs. Moreover, the operations of system 10 may be performed by more, fewer, or other system modules. Additionally, operations of system 10 may be performed using any suitable logic comprising software, hardware, other logic, or any suitable combination of the preceding.

FIG. 2 is a plan view of an exemplary green power payment device 30 in the form of a magnetic stripe card, in accordance with an embodiment of the invention. The exemplary green power payment device 30 comprises a plastic substrate 30(a). The exemplary green power payment device 30 also includes a contactless element 30(d) for interfacing in a contactless manner with an access device (e.g., a point of sale terminal) at merchant 40. The contactless element 30(d) may be located on or embedded within the plastic substrate 30(a). The exemplary green power payment device 30 also includes account information 30(b) including an account number (e.g., a primary account number (PAN)), the expiration date, and the name of the consumer 20. The account information 30(b) can be embossed or printed on the plastic substrate 30(a). The exemplary green power payment device 30 also includes a magnetic stripe 30(c).

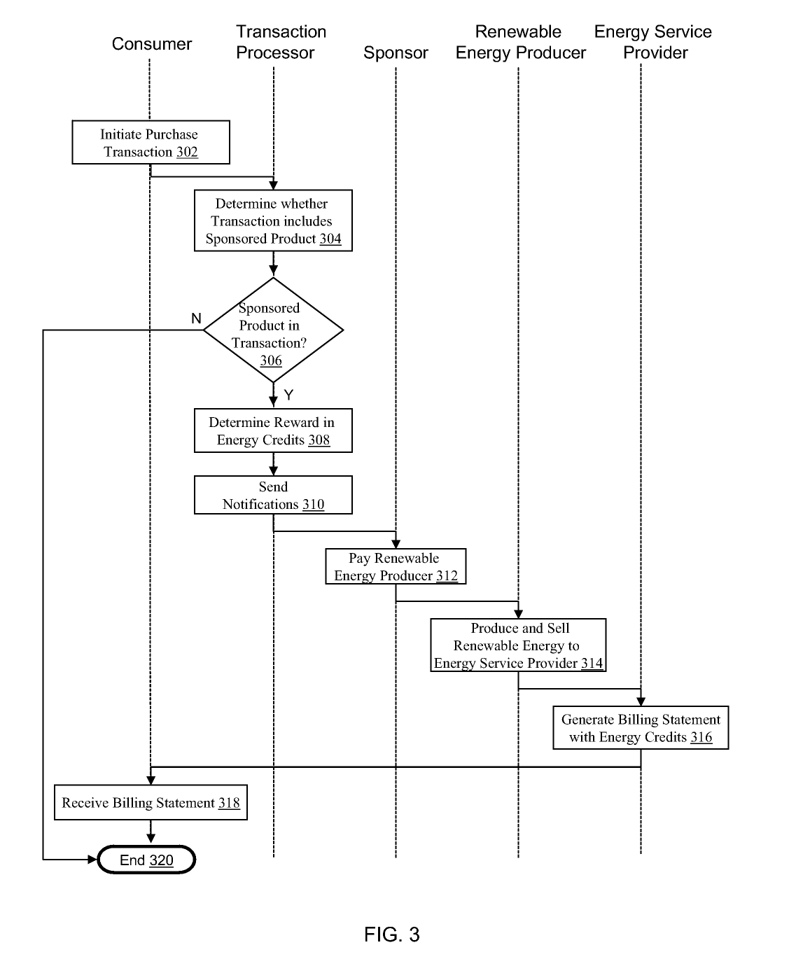

FIG. 3 shows a flowchart of an exemplary method for conducting transactions using a green power payment device 30 and for providing rewards associated with renewable energy production, in accordance with an embodiment of the invention.

The method starts with consumer 20 using the green power payment device 30 to initiate a purchase transaction at a merchant 40 (step 302). For example, consumer 20 may select items to buy at a merchant 40. To initiate the purchase transaction, consumer 20 may interact their green power payment device 30 with an access device (e.g., point of sale terminal) at merchant 40 by swiping it through a card reader or placing it near a contactless reader.

Once the transaction is initiated, the point of sale terminal sends a message with the transaction information such as the transaction amount and the product identifiers associated with the items to the server computer 50(a) of the transaction processor 60. The message may also include information such as the account number of the green power payment device 30, the merchant ID, and other information.

After receiving the message, the server computer 50(a) of the transaction processor 60 determines whether the transaction includes a sponsored product (step 304). The server computer 50(a) retrieves a list of sponsored products in the reward information. The list of sponsored products includes the product identifiers and sponsors associated with the sponsored products. The server computer 50(a) then compares the product identifiers in the transaction information to the list of sponsored products to determine whether the transaction includes a sponsored product. If the server computer 50(a) determines that the transaction does not include a sponsored product (step 306), the method ends (step 320).

If the transaction includes a sponsored product (step 306), the server computer 50(a) determines the reward in energy credit associated with the transaction (step 308). Server computer 50(a) retrieves the available offers for rewards in the reward information. Server computer 50(a) determines which of the available offers applies based on product identifiers in the transaction information. Once the server computer 50(a) determines which available offer(s) applies, server computer 50(a) can determine the reward from the applicable offers and the number of items or total price of the items purchased. For example, consumer 20 may buy 10 cups of coffee from Starbucks using their green power payment device 30. Server computer 50(a) determines that Starbucks is currently offering 10 KWh for every purchase of a cup of coffee from Starbucks. Server computer 50(a) determines the reward is 10 cups×10 KWh/cup =100 KWh. If multiple offers apply to the same products, server computer 50(a) may select offers from the multiple available offers that maximize the energy credit.

Server computer 50(a) updates the total energy credit associated with each sponsor 80 with new rewards from purchases of sponsored products. Each time a consumer 20 earns a new reward, server computer 50(a) retrieves the total energy credit associated with the sponsor 80 and updates the total energy credit with the energy credit in the new reward. Server computer 50(a) also updates the total energy credit earned by each consumer 20 with new rewards. Each time a consumer 20 earns a new reward, server computer 50(a) retrieves the total energy credit associated with the consumer 20 and updates the total energy credit with the energy credit in the new reward.

At some point after the reward in energy credit is determined for one or more consumers 20, server computer 50(a) of transaction processor 50 sends a first notification to server computer 60(a) of sponsor 60 and sends a second notification to server computer 80(a) of energy service provider 80 (step 310). The notifications can be sent periodically on any suitable basis such as hourly, daily, monthly, or yearly.

The first notification notifies the sponsor 60 of the rewards that have been earned by one or more consumers 20 during the time period (e.g., hour, day, month, or year). In some cases, the first notification may include the total energy credit associated with the sponsor 80 during the time period. For example, server computer 50(a) may send the sponsor 60 a message that 20,000 KWh of renewable energy was earned by purchases of sponsored products during the last month. In other cases, the first notification may include the total energy credit earned by a single consumer 20 for purchases of sponsored products during the last time period. For example, server computer 50(a) may send sponsor 60 a message that consumer X earned 1000 KWh of renewable energy by purchasing sponsored products during the last month.

The second notification notifies the energy service provider 80(a) of rewards earned by each consumer 20 during the last time period (e.g., hour, day, month, or year). The second notification includes the total energy credit earned by each consumer 20 along with identifying information for the consumer 20. In an exemplary embodiment, the second notification is sent to the energy service provider 80 on a monthly basis and includes the total energy credit earned by the consumer 20 during that month. In another embodiment, the second notification is sent to the energy service provider 80 on a daily basis and includes total rewards earned by the consumer 20 on that day.

After the first notification is sent, the server computer 50(a) zeroes out the total energy credit associated with the sponsor 80 that received the first notification. After the second notification is sent, the server computer 50(a) zeroes out the total energy credit associated with the sponsor 80 that received the second notification.

At some point after the sponsor 60 receives the first notification, sponsor 60 pays the renewable energy producer 70 an amount associated with the total energy credit associated with that sponsor 60 during that time period (Step 312). The total energy credit is provided in the first notification. The pay rate for the energy credit may be provided by the renewable energy producer 70, a government entity, or other suitable entity. Server computer 60(a) of sponsor 80 determines the amount of the payment for the energy credit by multiplying the pay rate with the energy credit. For example, if the pay rate is $0.25/KWh and the energy credit in the rewards is 1000 KWh, the payment to renewable energy producer 70 is $0.25/KWh×1000 KWh=$25.00.

In one embodiment, server computer 50(a) may determine that the rewards are associated with multiple sponsors 60. In this embodiment, a first notification is sent to each of the multiple sponsors 60. In response, each sponsor 60 pays the renewable energy producer 60 an amount associated with the energy credit that is associated with the sponsor 60.

In return for the payment, renewable energy producer 70 provides RECs to sponsor 60. The price of an REC may be set by the renewable energy producer 70, a government entity, other suitable entity, or by an open market. Server computer 70(a) of renewable energy producer 70 determines the number of RECs associated with the payment using the price of the REC and the payment made by sponsor 60. For example, if the price of an REC is $5000.00 and the payment made by sponsor 60 is $2500.00, then the sponsor 60 will get ½ REC.

To continue providing RECs to the sponsor 60, the renewable energy producer 70 produces and sells renewable energy to the energy service provider 80 (step 314). Server computer 80(a) of energy service provider 80 may determine the price of the renewable energy purchased from renewable energy producer 70 taking into account the cost of the energy credit provided to consumer 20. The price of the renewable energy sold to the energy service provider 80 will be based on a set price for renewable energy provided by various entities minus the price that energy service provider 80 charges for electricity. For example, the set price for renewable energy may be $0.25/KWh and the energy service provider 80 may charge $0.10/KWh for electricity to the consumer 20. The price of the renewable energy will be $0.25/KWh−$0.10/KWh=$0.15/KWh. By subtracting the price that the energy service provider 80 charges for electricity from the set price of renewable energy, the energy service provider 80 provides a net value of $0.25 KWh in exchange for the renewable energy.

The set price of the renewable energy may be set by energy service provider 80, by a government entity, or other suitable entity. For example, a state government may set the price (e.g., $0.25/KWh) that an energy service provider 80 can give in value in exchange for renewable energy provided by an eligible renewable energy producer 70.

The server computer 80(a) of energy service provider 80 determines the payment amount for the renewable energy received from renewable energy producer 70 based on the determined price and the amount of renewable energy provided by renewable energy producer 70. For example, if the amount of renewable energy provided is 1000 KWh and the price is $0.15/KWh, then the payment to the energy service provider 80 is 1000 KWh×$0.15/KWh=$15.00. In some cases, the determined price may only apply to the amount of renewable energy that is associated with the payment from sponsor 60. Any supplemental renewable energy sold to energy service provider 80 by renewable energy producer 70 may have a different price. For example, if sponsors pay for 10,000 KWh of energy credit during a month and renewable energy producer 70 generates 20,000, then the first 10,000 KWh may be sold at the determined price (e.g., $0.15/KWh) and the supplemental 10,000 KWh may be sold at the set price (e.g., $0.25/KWh).

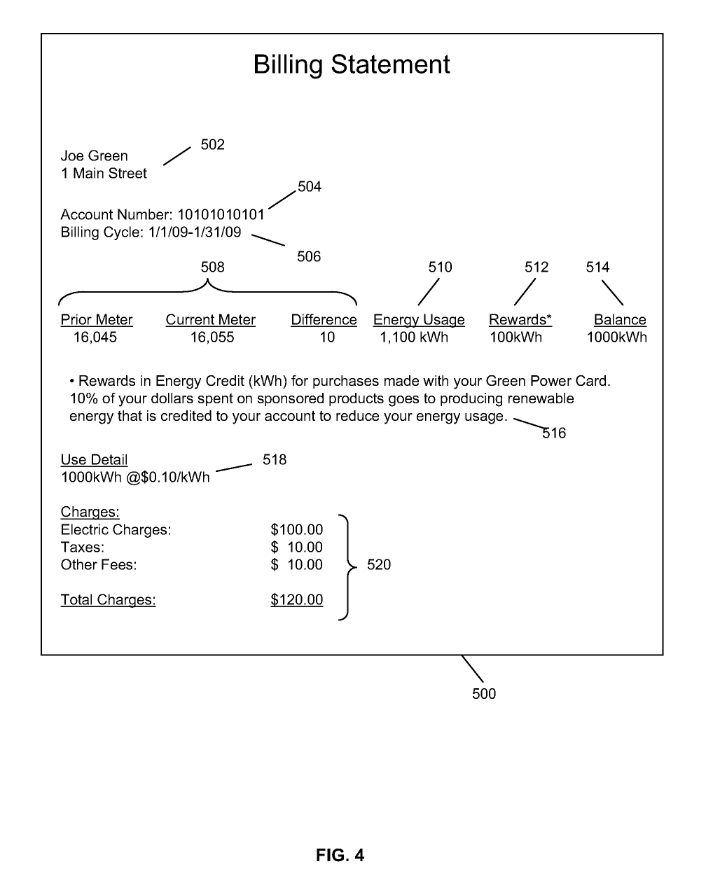

At some point after the energy service provider 80 receives the second notification, server computer 80(a) of energy service provider 80 credits the energy account associated with the consumer 20 with the determined energy credit. Server computer 80(a) of energy service provider 80 then generates a billing statement 500 for the current billing period (step 316). The billing statement 500 includes energy credit earned by the consumer 20 during that billing period as provided in the second notification. An exemplary billing statement 500 is shown in FIG. 4.

The consumer receives the billing statement 500 (step 318). The consumer 20 can access the billing statement 500 in any suitable manner. For example, consumer 20 may access the billing statement 500 online through a website on a web browser displayed on a computer. The website may be provided by a web server on server computer 80(a) of energy service provider 80. Consumer 20 may enter authenticating information to access their account information on the website. In another example, consumer 20 may receive the billing statement 500 in paper form through the U.S. Postal Service. After the consumer 20 receives the billing statement 500, the method ends (step 320).

FIG. 4 is an exemplary billing statement 500 that shows a reward in the form of an energy credit applied to the energy usage 510, in accordance with an embodiment of the invention. Billing statement 500 includes consumer information 502 with a name and billing address, account information 504, billing cycle 506, energy usage 510, rewards 512, balance 514, information about the rewards 516, use detail 518, and charges 520. Other embodiments may include other information instead of or in addition to the information in the exemplary billing statement 500. The account information 504 include an account number and the billing cycle 506 for the billing statement 500. The information 508 includes the prior meter reading from the previous billing cycle, the current meter reading, and the difference in the meter readings. The energy usage 510 is determined from the difference in meter readings. The rewards are shown as 100 KWh. The balance 514 is the net balance of energy of 1000 KWh after reducing the energy usage of 1,100 KWh by the energy credit of 100 KWh in the rewards. The use detail 518 describes the price of the energy to the consumer 20. The charges 520 include the electric charges, taxes, fees, and the total charges to the consumer 20.

FIG. 5 shows a block diagram of subsystems that may be present in computer apparatuses that are used in system 10, according to embodiments of the disclosure.

Various entities and elements of the entities in the previously described FIGS. 1-4 may operate using one or more computer apparatuses to facilitate the functions described herein. Any of the elements of entities may use any suitable number of subsystems to facilitate the functions described herein. Examples of such subsystems are shown in a FIG. 5.

The subsystems shown in FIG. 5 are interconnected via a system bus 300. Additional subsystems such as a keyboard 314, mouse 316, a monitor 320 coupled to a display adapter 318, a printer 322, and a fixed disk 312, other memory 304, and other subsystems are shown. Peripherals and input/output (I/O) devices, which couple to I/O controller 306, can be connected to the computer apparatus by any number of means known in the art, such as serial port 310. For example, serial port 310 or external interface 308 can be used to connect the computer apparatus to a wide area network such as the Internet, mouse 316, or to a scanner (not shown). The interconnection via the system bus 300 allows the central processing unit 302 to communicate with each subsystem and to control the execution of instructions from system memory 304 or from fixed disk 312, as well as the exchange of information between subsystems. The system memory 304 and/or the fixed disk 312 may embody a computer readable medium. Any of these elements may be present in the previously described features.

It should be understood that the present invention as described above can be implemented in the form of control logic using computer software in a modular or integrated manner. Other ways and/or methods to implement the present invention using hardware and a combination of hardware and software may also be used.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

A recitation of “a”, “an” or “the” is intended to mean “one or more” unless specifically indicated to the contrary.

The above description is illustrative and is not restrictive. Many variations of the disclosure will become apparent to those skilled in the art upon review of the disclosure. The scope of the disclosure should, therefore, be determined not with reference to the above description, but instead should be determined with reference to the pending claims along with their full scope or equivalents.

One or more features from any embodiment may be combined with one or more features of any other embodiment without departing from the scope of the disclosure. Further, modifications, additions, or omissions may be made to any embodiment without departing from the scope of the disclosure. The components of any embodiment may be integrated or separated according to particular needs without departing from the scope of the disclosure.

What is claimed is:

1. A server computer, comprising:
a processor; and
a computer readable medium coupled to the processor, wherein the computer readable medium comprises code executable by the processor, the computer readable medium comprising:
code for receiving transaction information associated with a purchase transaction of a sponsored product between a consumer and a merchant using a payment device;
code for determining an energy credit based on the transaction information associated with the purchase transaction of the sponsored product;
code for sending a first notification to a sponsor associated with the sponsored product, wherein the first notification comprises a portion of the transaction information, wherein the sponsor makes a payment associated with the determined energy credit to a renewable energy producer in response to receiving the first notification; and
code for sending a second notification with the determined energy credit to an energy provider, wherein the energy provider credits the energy service account of the consumer with the determined energy credit in response to receiving the second notification.

2. The server computer of claim 1, wherein the sponsor receives renewable energy certificates from the renewable energy producer associated with the payment to the renewable energy producer.

3. The server computer of claim 1, wherein the renewable energy producer provides renewable energy to the energy provider corresponding to the determined energy credit in response to receiving the payment, and wherein the renewable energy producer receives renewable energy certificates corresponding to the provided renewable energy from the energy provider.

4. The server computer of claim 1, wherein the transaction information includes the amount of the transaction, the energy credit, and an identifier of the sponsor associated with the sponsored product.

5. The server computer of claim 1, wherein the payment device is a credit card.

6. A method comprising:
receiving, by a server computer, transaction information associated with a purchase transaction of a sponsored product between a consumer and a merchant using a payment device;
determining, by a server computer, an energy credit based on the transaction information associated with the purchase transaction of the sponsored product;
sending, by a server computer, a first notification to a sponsor associated with the sponsored product, wherein the first notification comprises a portion of the transaction information, wherein the sponsor makes a payment associated with the determined energy credit to a renewable energy producer in response to receiving the first notification; and
sending, by a server computer, a second notification with the determined energy credit to an energy provider, wherein the energy provider credits the energy service account of the consumer with the determined energy credit in response to receiving the second notification.

7. The method of claim 6, wherein the sponsor also receives renewable energy certificates from the renewable energy producer associated with the payment to the renewable energy producer.

8. The method of claim 6, wherein the renewable energy producer provides renewable energy to the energy provider corresponding to the determined energy credit in response to receiving the payment, and wherein the renewable energy producer receives renewable energy certificates corresponding to the provided renewable energy from the energy provider.

9. The method of claim 6, wherein the transaction information includes the amount of the transaction, the energy credit, and an identifier of the sponsor associated with the sponsored product.

10. The method of claim 6, wherein the payment device is a credit card.

11. A method comprising:
initiating sending transaction information to a server computer of a transaction processor, wherein the transaction information is associated with a purchase transaction of a sponsored product between a consumer and a merchant using a payment device, wherein the server computer of the transaction processor determines an energy credit based on the transaction information associated with the purchase transaction of the sponsored product, sends a first notification to a sponsor associated with the sponsored product with a portion of the transaction information, and sends a second notification with the determined energy credit to an energy provider server; and
receiving a billing statement from the energy service provider indicating that the energy credit is credited to an energy service account.

12. The method of claim 11, wherein the energy provider server credits the energy service account of the consumer with the determined energy credit from the second notification.

13. The method of claim 11, wherein the energy provider server also generates the billing statement indicating that the energy credit is credited to the energy service account.

14. The method of 11, wherein the sponsor makes a payment associated with the determined energy credit to a renewable energy producer in response to receiving the first notification.

15. The method of claim 11, wherein the renewable energy producer provides renewable energy to the energy service provider corresponding to the determined energy credit in response to receiving the payment, and wherein the renewable energy producer receives renewable energy certificates corresponding to the provided renewable energy from the energy provider.

17. The method of claim 11, wherein in response to receiving the second notification, the sponsor purchases from a renewable energy producer renewable energy corresponding to the determined energy credit.

18. The method of claim 11, wherein the payment device is a credit card.
